(19) United States
(12) Patent Application Publication
(10) Pub. No.: US 2024/0355344 A1
(43) Pub. Date: Oct. 24, 2024

(54) AUDIO SIGNAL RECONSTRUCTION

(71) Applicant: QUALCOMM Incorporated, San Diego, CA (US)

(72) Inventors: Zisis Iason SKORDILIS, San Diego, CA (US); Duminda DEWASURENDRA, San Diego, CA (US); Vivek RAJENDRAN, San Diego, CA (US)

(21) Appl. No.: 18/684,074

(22) PCT Filed: Sep. 9, 2022
(86) PCT No.: PCT/US22/76172

§ 371 Date: Feb. 15, 2024

(30) Foreign Application Priority Data
Oct. 18, 2021 (GR) 20210100708

(51) Int. Cl. G10L 19/02; G10L 19/032; G10L 25/18; G10L 25/30

(52) U.S. Cl. CPC G10L 19/0204; G10L 19/032; G10L 25/18; G10L 25/30

(57) ABSTRACT

A method includes receiving audio data that includes magnitude spectrum data descriptive of an audio signal. The method also includes providing the audio data as input to a neural network to generate an initial phase estimate for one or more samples of the audio signal. The method further includes determining, using a phase estimation algorithm, target phase data for the one or more samples of the audio signal based on the initial phase estimate and a magnitude spectrum of the one or more samples of the audio signal indicated by the magnitude spectrum data. The method also includes reconstructing the audio signal based on a target phase of the one or more samples of the audio signal indicated by the target phase data and based on the magnitude spectrum.

### I. CROSS-REFERENCE TO RELATED APPLICATIONS

The present application claims the benefit of priority from the commonly owned Greece Provisional Patent Application No. 20210100708, filed Oct. 18, 2021, the contents of which are expressly incorporated herein by reference in their entirety.

### II. FIELD

The present disclosure is generally related to audio signal reconstruction.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Mobile devices, such as mobile phones, can be used to encode and decode audio. As a non-limiting example, a first mobile device can detect speech from a user and encode the speech to generated encoded audio signals. The encoded audio signals can be communicated to a second mobile device and, upon receiving the encoded audio signals, the second mobile device can decode the audio signals to reconstruct the speech for playback. In some scenarios, complex circuits can be used to decode audio signals. However, complex circuits can leave a relatively large memory footprint. In other scenarios where complex circuits are not used to reconstruct the speech, reconstruction of the speech include time-intensive operations. For example, speech reconstruction algorithms requiring multiple iterations can be used to reconstruct the speech. As a result of the multiple iterations, processing efficiency may be diminished.

### IV. SUMMARY

According to one implementation of the present disclosure, a device includes a memory and one or more processors coupled to the memory. The one or more processors are operably configured to receive audio data that includes magnitude spectrum data descriptive of an audio signal. The one or more processors are also operably configured to provide the audio data as input to a neural network to generate an initial phase estimate for one or more samples of the audio signal. The one or more processors are also operably configured to determine, using a phase estimation algorithm, target phase data for the one or more samples of the audio signal based on the initial phase estimate and a magnitude spectrum of the one or more samples of the audio signal indicated by the magnitude spectrum data. The one or more processors are further operably configured to reconstruct the audio signal based on a target phase of the one or more samples of the audio signal indicated by the target phase data and based on the magnitude spectrum.

According to another implementation of the present disclosure, a method includes receiving audio data that includes magnitude spectrum data descriptive of an audio signal. The method also includes providing the audio data as input to a neural network to generate an initial phase estimate for one or more samples of the audio signal. The method further includes determining, using a phase estimation algorithm, target phase data for the one or more samples of the audio signal based on the initial phase estimate and a magnitude spectrum of the one or more samples of the audio signal indicated by the magnitude spectrum data. The method also includes reconstructing the audio signal based on a target phase of the one or more samples of the audio signal indicated by the target phase data and based on the magnitude spectrum.

According to another implementation of the present disclosure, a non-transitory computer-readable medium includes instructions that, when executed by one or more processors, cause the one or more processors to receive audio data that includes magnitude spectrum data descriptive of an audio signal. The instructions, when executed by the one or more processors, further cause the one or more processors to provide the audio data as input to a neural network to generate an initial phase estimate for one or more samples of the audio signal. The instructions, when executed by the one or more processors, also cause the one or more processors to determine, using a phase estimation algorithm, target phase data for the one or more samples of the audio signal based on the initial phase estimate and a magnitude spectrum of the one or more samples of the audio signal indicated by the magnitude spectrum data. The instructions, when executed by the one or more processors, further cause the one or more processors to reconstruct the audio signal based on a target phase of the one or more samples of the audio signal indicated by the target phase data and based on the magnitude spectrum.

According to another implementation of the present disclosure, an apparatus includes means for receiving audio data that includes magnitude spectrum data descriptive of an audio signal. The apparatus also includes means for providing the audio data as input to a neural network to generate an initial phase estimate for one or more samples of the audio signal. The apparatus further includes means for determining, using a phase estimation algorithm, target phase data for the one or more samples of the audio signal based on the initial phase estimate and a magnitude spectrum of the one or more samples of the audio signal indicated by the magnitude spectrum data. The apparatus also includes means for reconstructing the audio signal based on a target phase of the one or more samples of the audio signal indicated by the target phase data and based on the magnitude spectrum.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of a particular illustrative aspect of a system configured to reconstruct an audio signal using a neural network and a phase estimation algorithm, in accordance with some examples of the present disclosure.

FIG. 2 is a block diagram of a particular illustrative aspect of a system configured to use a phase estimation algorithm to reconstruct an audio signal based on an initial phase estimate from a neural network, in accordance with some examples of the present disclosure.

FIG. 3 is a block diagram of a particular illustrative aspect of a system configured to provide feedback to a neural network based on a reconstructed audio signal, in accordance with some examples of the present disclosure.

FIG. 4 is a block diagram of a particular illustrative aspect of a system configured to generate an initial phase estimate for a phase estimation algorithm, in accordance with some examples of the present disclosure.

FIG. 5 is a diagram of a particular implementation of a method of reconstructing an audio signal, in accordance with some examples of the present disclosure.

FIG. 6 is a diagram of a particular example of components of a decoding device in an integrated circuit.

FIG. 7 is a diagram of a mobile device that includes circuity configured to reconstruct an audio signal using a neural network and a phase estimation algorithm, in accordance with some examples of the present disclosure.

FIG. 8 is a diagram of a headset that includes circuity configured to reconstruct an audio signal using a neural network and a phase estimation algorithm, in accordance with some examples of the present disclosure.

FIG. 9 is a diagram of a wearable electronic device that includes circuity configured to reconstruct an audio signal using a neural network and a phase estimation algorithm, in accordance with some examples of the present disclosure.

FIG. 10 is a diagram of a voice-controlled speaker system that includes circuity configured to reconstruct an audio signal using a neural network and a phase estimation algorithm, in accordance with some examples of the present disclosure.

FIG. 11 is a diagram of a camera that includes circuity configured to reconstruct an audio signal using a neural network and a phase estimation algorithm 1, in accordance with some examples of the present disclosure.

FIG. 12 is a diagram of a headset, such as a virtual reality, mixed reality, or augmented reality headset, that includes circuity configured to reconstruct an audio signal using a neural network and a phase estimation algorithm, in accordance with some examples of the present disclosure.

FIG. 13 is a diagram of a first example of a vehicle that includes circuity configured to reconstruct an audio signal using a neural network and a phase estimation algorithm, in accordance with some examples of the present disclosure.

FIG. 14 is a diagram of a second example of a vehicle that includes circuity configured to reconstruct an audio signal using a neural network and a phase estimation algorithm, in accordance with some examples of the present disclosure.

FIG. 15 is a block diagram of a particular illustrative example of a device that is operable to reconstruct an audio signal using a neural network and a phase estimation algorithm, in accordance with some examples of the present disclosure.

### VI. DETAILED DESCRIPTION

Systems and methods of reconstructing an audio signal using a neural network and a phase estimation algorithm are disclosed. To illustrate, a mobile device can receive an encoded audio signal. As a non-limiting example, captured speech can be generated into an audio signal and encoded at a remote device, and the encoded audio signal can be communicated to the mobile device. In response to receiving the encoded audio signal, the mobile device can perform decoding operations to extract audio data associated with different features of the audio signal. To illustrate, the mobile device can perform the decoding operations to extract magnitude spectrum data that are descriptive of the audio signal.

The retrieved audio data can be provided as input to a neural network. For example, the magnitude spectrum data can be provided as inputs to the neural network, and the neural network can generate a first audio signal estimate based on the magnitude spectrum data. To reduce a memory footprint, the neural network can be a low-complexity neural network (e.g., a low-complexity autoregressive generative neural network). An initial phase estimate for one or more samples of the audio signal can be identified based on a phase of the first audio signal estimate generated by the neural network.

The initial phase estimate, along with a magnitude spectrum indicated by the magnitude spectrum data extracted from the decoding operations, can be used by a phase estimation algorithm to determine a target phase for the one or more samples of the audio signal. As a non-limiting example, the mobile device can use a Griffin-Lim algorithm to determine the target phase based on the initial phase estimate and the magnitude spectrum. The “Griffin-Lim algorithm” corresponds to a phase reconstruction algorithm based on redundancy of a short-term Fourier transform. As used herein, the “target phase” corresponds to a phase estimate that is consistent with the magnitude spectrum such that a reconstructed audio signal having the target phase sounds substantially the same as the original audio signal. In some scenarios, the target phase can correspond to a replica of the phase of the original audio signal. In other scenarios, the target phase can be different from the phase of the original audio signal. Because the phase estimation algorithm is initialized using the initial phase estimate determined based on an output of the neural network, as opposed to using a random or default phase estimate, the phase estimation algorithm can undergo a relatively small number of iterations (e.g., one iteration, two iterations, fewer than five iterations, fewer than twenty iterations, etc.) to determine the target phase for the one or more samples of the audio signal. As a non-limiting example, the target phase can be determined based on a single iteration of the phase estimation algorithm, as opposed to using hundreds of iterations if the phase estimation algorithm was initialized using a random or default phase estimate. As a result, processing efficiency and other performance timing metrics can be improved. By using the target phase and the magnitude spectrum indicated by the magnitude spectrum data extracted from the decoding operations, the mobile device can reconstruct the audio signal and can provide reconstructed audio signal to a speaker for playout.

Thus, the techniques described herein enables the use of a low-complexity neural network to reconstruct an audio signal that matches a target audio signal by combining the neural network with a phase estimation algorithm. Without combining the neural network with the phase estimation algorithm, generating high quality audio output using solely a neural network alone can require a very large and complex neural network. By using a phase estimation algorithm to perform processing (e.g., post-processing) on an output of the neural network, the complexity of the neural network can be significantly reduced while maintaining high audio quality. The reduction of complexity of the neural network enables the neural network to run in a typical mobile device without high battery drain. Without enabling such complexity reduction on the neural network, it may not be possible to run a neural network to obtain high quality audio in a typical mobile device. It should also be appreciated that by combining the neural network with the phase estimation algorithm, a relatively small number of iterations (e.g., one or two iterations) of the phase estimation algorithm can be undergone to determine the target phase as opposed to the large number of iterations (e.g., between one-hundred and five-hundred iterations) that would typically have to be undergone if the neural network is absent.

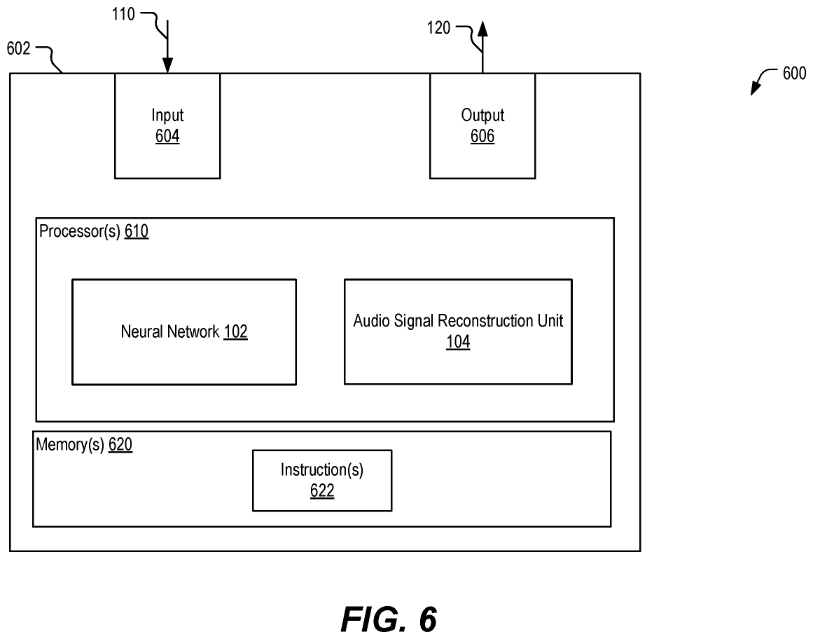

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 6 depicts an implementation 600 including one or more processors (“processor(s)” 610 of FIG. 6), which indicates that in some scenarios the implementation 600 includes a single processor 610 and in other scenarios the implementation 600 includes multiple processors 610. For ease of reference herein, such features are generally introduced as “one or more” features and are subsequently referred to in the singular unless aspects related to multiple of the features are being described.

It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

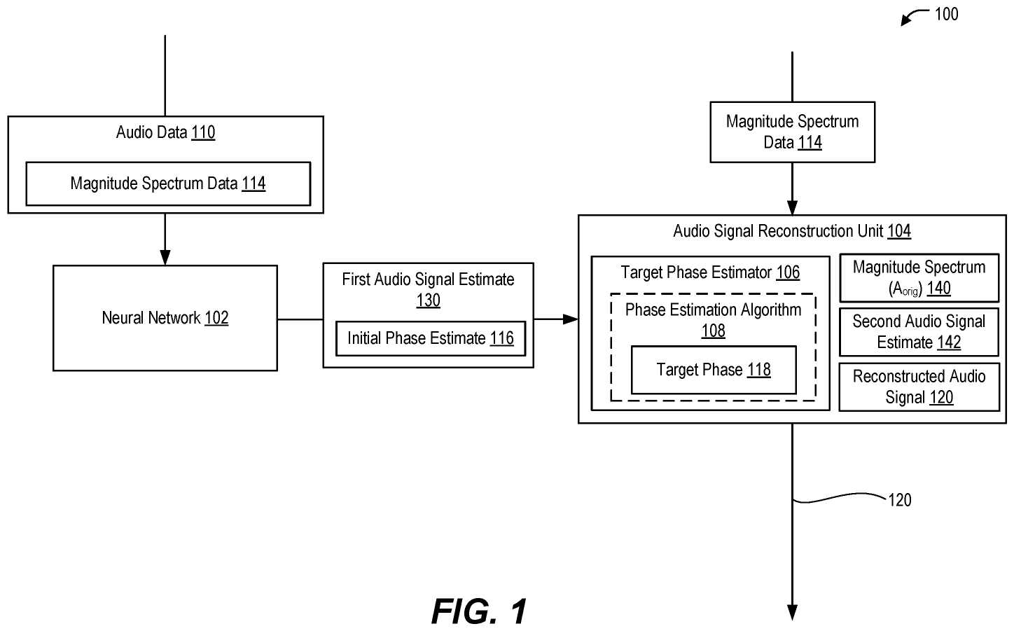

Referring to FIG. 1, a particular illustrative aspect of a system configured to reconstruct an audio signal using a neural network and a phase estimation algorithm is disclosed and generally designated 100. The system 100 includes a neural network 102 and an audio signal reconstruction unit 104. According to one implementation, the neural network 102 and the audio reconstruction signal unit 104 can be integrated into a mobile device. As non-limiting examples, the neural network 102 and the audio reconstruction signal unit 104 can be integrated into a mobile phone, a wearable device, a headset, a vehicle, a drone, a laptop, etc. In some implementations, the neural network 102 and the audio reconstruction signal unit 104 can be integrated into a decoder of a mobile device. According to another implementation, the neural network 102 and the audio reconstruction signal unit 104 can be integrated into other devices (e.g., non-mobile devices). As non-limiting examples, the neural network 102 and the audio reconstruction signal unit 104 can be integrated into a computer, an internet-of-things (IoT) device, etc.

The neural network 102 can be configured to receive audio data 110. According to one implementation, the audio data 110 can correspond to dequantized values received from an audio decoder (not shown). For example, the audio decoder can perform decoding operations to extract (e.g., retrieve, decode, generate, etc.) the audio data 110. The audio data 110 includes magnitude spectrum data 114 descriptive of an audio signal. According to one example, the “audio signal” can correspond to a speech signal that was encoded at a remote device and communicated to a device associated with the system 100. Although the magnitude spectrum data 114 is illustrated in FIG. 1, in other implementations, data descriptive of other features (e.g., speech features) can be included in the audio data 110. As a non-limiting example, the audio data 110 can also include pitch data descriptive of the audio signal, phase estimation data descriptive of the audio signal, etc.

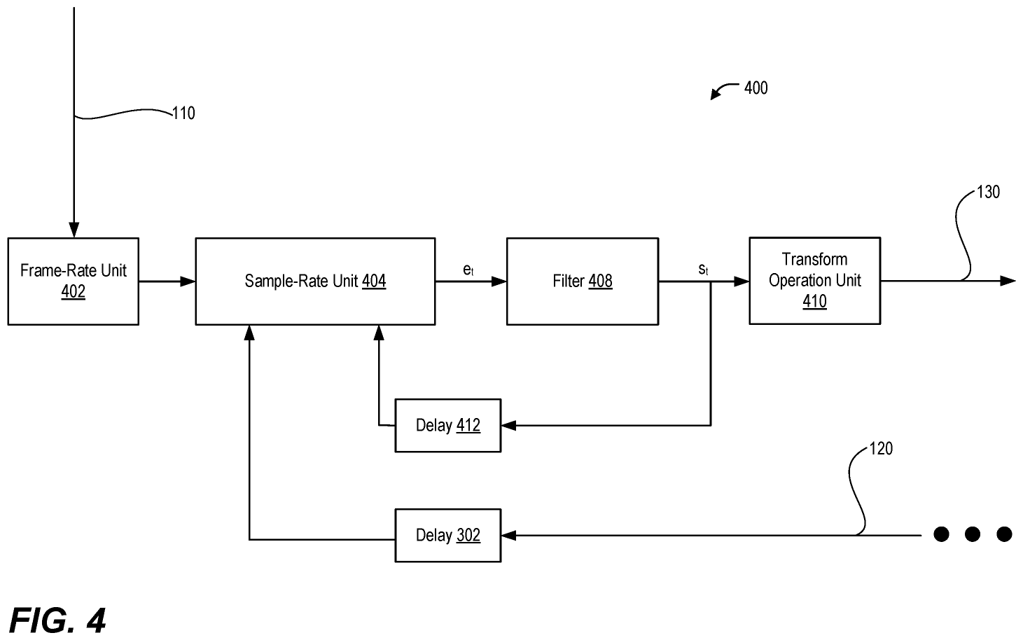

The neural network 102 can be configured to generate an initial phase estimate 116 for one or more samples of the audio signal based on the audio data 110. For example, as described with respect to FIG. 4, the neural network 102 can generate a first audio signal estimate 130 based on the audio data 110. The first audio signal estimate 130 can correspond to a preliminary (or initial) reconstruction of the one or more samples of the audio signal in the time domain. A transform operation (e.g., a short-time Fourier transform (STFT) operation) can be performed on the first audio signal estimate 130 to generate the initial phase estimate 116 for the one or more samples of the audio signal c. The initial phase estimate 116 is provided to the audio signal reconstruction unit 104.

The neural network 102 can be a low-complexity neural network that has a relatively small memory footprint and consumes a relatively small amount of processing power. The neural network 102 can be an autoregressive neural network. According to one implementation, the neural network 102 can be a single-layer recurrent neural network (RNN) for audio generation, such as a WaveRNN. One example of a WaveRNN is an LPCNet.

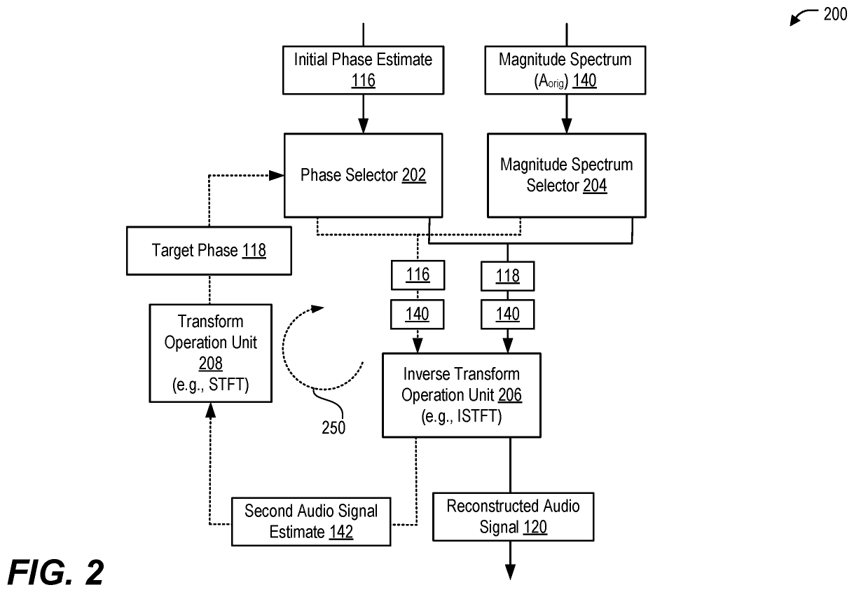

The audio signal reconstruction unit 104 includes a target phase estimator 106. The target phase estimator 106 can be configured to run a phase estimation algorithm 108 to determine a target phase 118 for the one or more samples of the audio signal. As a non-limiting example and as further described with respect to FIG. 2, the phase estimation algorithm 108 can correspond to a Griffin-Lim algorithm. However, in other implementations, the phase estimation algorithm 108 can correspond to other algorithms. As non-limiting examples, the phase estimation algorithm 108 can correspond to a Gerchberg-Saxton (GS) algorithm, a Wirtinger Flow (WF) algorithm, etc.

In general, the phase estimation algorithm 108 can correspond to any signal processing algorithm (or speech processing algorithm) that estimates spectral phase from a redundant representation of spectral magnitude. To illustrate, the magnitude spectrum data 114, when processed by the audio signal reconstruction unit 104, can indicate a magnitude spectrum 140 (e.g., an original magnitude spectrum (A_{orig}) 140) of the one or more samples of the audio signal. The magnitude spectrum (A_{orig}) 140 can correspond to a windowed short-time magnitude spectrum that overlaps with an adjacent windowed short-time magnitude spectrum. For example, a first window associated with a first portion of the magnitude spectrum (A_{orig}) 140 can overlap a second window associated with a second portion of the magnitude spectrum (A_{orig}) 140. In this example, the first portion of the magnitude spectrum (A_{orig}) 140 corresponds to a magnitude spectrum of a first sample of the one or more samples of the audio signal, and the second portion of the magnitude spectrum (A_{orig}) 140 corresponds to a magnitude spectrum of a second sample of the one or more samples of the audio signal. According to one implementation, at least fifty percent of the first window overlaps at least fifty percent of the second window. According to another implementation, one sample of the first window overlaps one sample of the second window.

Based on the original magnitude spectrum (A_{orig}) 140 and the initial phase estimate 116, the target phase estimator 106 can run the phase estimation algorithm 108 to determine the target phase 118 of the one or more samples of the audio signal. For example, the target phase estimator 106 can perform an inverse transform operation (e.g., an inverse short-time Fourier transform (ISTFT) operation) based on the initial phase estimate 116 and the original magnitude spectrum (A_{orig}) 140 to generate a second audio signal estimate 142. The second audio signal estimate 142 can correspond to a preliminary (or initial) reconstruction of the one or more samples of the audio signal in the time domain. By performing a transform operation (e.g., a STFT operation) on the second audio signal estimate 142, the target phase 118 can be determined. The audio signal reconstruction unit 104 can be configured to perform an inverse transform operation (e.g., an ISTFT operation) based on the target phase 118 and the original magnitude spectrum (A_{orig}) 140 to generate a reconstructed audio signal 120.

The techniques described with respect to FIG. 1 reduce a memory footprint associated with generating the reconstructed audio signal 120 by using a low-complexity neural network 102. Additionally, because the phase estimation algorithm 108 is initialized using the initial phase estimate 116 determined based on an output of the neural network 102, as opposed to using a random or default phase estimate (e.g., a phase estimate that is not based on the audio data 110), the phase estimation algorithm 108 can undergo a relatively small number of iterations to determine the target phase 118 for the reconstructed audio signal 120. As a non-limiting example, the target phase estimator 106 can determine the target phase 118 based on a single iteration of the phase estimation algorithm 108 as opposed to using hundreds of iterations if the phase estimation algorithm 108 was initialized using a random phase estimate. As a result, processing efficiency and other performance metrics (such as power utilization) can be improved.

Referring to FIG. 2, a particular illustrative aspect of a system configured to use a phase estimation algorithm to reconstruct an audio signal based on an initial phase estimate from a neural network is disclosed and generally designated 200. The system 200 includes a phase selector 202, a magnitude spectrum selector 204, an inverse transform operation unit 206, and a transform operation unit 208. According to one implementation, the phase selector 202, the magnitude spectrum selector 204, the inverse transform operation unit 206, and the transform operation unit 208 can be integrated into the audio signal reconstruction unit 104 of FIG. 1.

According to one implementation, the system 200 illustrates a non-limiting example of running the phase estimation algorithm 108. As a non-limiting example, the system 200 can depict a single iteration 250 of a Griffin-Lim algorithm used by the audio signal reconstruction unit 104 to generate the reconstructed audio signal 120. The single iteration 250 can be used to determine the target phase 118 and is depicted by the dotted lines. As described below, in response to determining the target phase 118, the reconstructed audio signal 120 can be generated based on the target phase 118 and the original magnitude spectrum (A_{orig}) 140.

According to the example of FIG. 2, the initial phase estimate 116 from the neural network 102 is provided to the phase selector 202, and the original magnitude spectrum (A_{orig}) 140 indicated by the magnitude spectrum data 114 is provided to the magnitude spectrum selector 204. The phase selector 202 can select the initial phase estimate 116 to initialize the phase estimation algorithm 108, and the magnitude spectrum selector 204 can select the original magnitude spectrum (A_{orig}) 140 to initialize the phase estimation algorithm 108. As a result, during the single iteration 250, the initial phase estimate 116 and the original magnitude spectrum (A_{orig}) 140 are provided to the inverse transform operation unit 206.

The inverse transform operation unit 206 can be configured to perform an inverse transform operation based on the initial phase estimate 116 and the original magnitude spectrum (A_{orig}) 140 to generate the second audio signal estimate 142. As a non-limiting example, the inverse transform operation unit 206 can perform an ISTFT operation using the initial phase estimate 116 and the original magnitude spectrum (A_{orig}) 140 to generate the second audio signal estimate 142, such that xᵣ=ISTFT(A_{orig}×e^{jθr}), where xᵣ corresponds to the second audio signal estimate 142 and θᵣ corresponds to the initial phase estimate 116. Although an ISTFT operation is described, in other implementations, the inverse transform operation unit 206 can perform other inverse transform operations based on the initial phase estimate 116 and the original magnitude spectrum (A_{orig}) 140. As non-limiting examples, the inverse transform operation unit 206 can perform an inverse Fourier transform operation, an inverse discrete Fourier transform operation, etc.

The transform operation unit 208 can be configured to perform a transform operation on the second audio signal estimate 142 to determine the target phase 118. As a non-limiting example, the transform operation unit 208 can perform a STFT operation on the second audio signal estimate 142 to generate a frequency-domain signal (not illustrated). The frequency domain signal can have a phase (e.g., the target phase 118) and a magnitude (e.g., a magnitude spectrum). Because of the significant window overlap associated with the original magnitude spectrum (A_{orig}) 140, the target phase 118 is slightly different from the initial phase estimate 116. The target phase 118 is provided to the phase selector 202 for use in generating the reconstructed audio signal 120. The magnitude of the frequency-domain signal can be discarded. Although an STFT operation is described, in other implementations, the transform operation unit 208 can perform other transform operations on the second audio signal estimate 142. As non-limiting examples, the transform operation unit 208 can perform a Fourier transform operation, a discrete Fourier transform operation, etc.

After the single iteration 250, the phase selector 202 can select the target phase 118 to provide to the inverse transform operation unit 206 and the magnitude spectrum selector 204 can select the original magnitude spectrum (A_{orig}) 140 to provide to the inverse transform operation unit 206. The inverse transform operation unit 206 can be configured to perform an inverse transform operation based on the target phase 118 and the original magnitude spectrum (A_{orig}) 140 to generate the reconstructed audio signal 120. As a non-limiting example, the inverse transform operation unit 206 can perform an ISTFT operation using the target phase 118 and the original magnitude spectrum (A_{orig}) 140 to generate the reconstructed audio signal 120, such that x_{r,new}=ISTFT(A_{orig}×e^{jθr,new}), where x_{r,new} corresponds to the reconstructed audio signal 120 and θ_{r,new} corresponds to the target phase 118.

It should be understood that the techniques described with respect to FIG. 2 merely depict one non-limiting example of the phase estimation algorithm 108. Other phase estimation algorithms and implementations can be used to generate the reconstructed audio signal 120 based on the initial phase estimate 116 from the neural network 102.

The techniques described with respect to FIG. 2 can result in a reduced number of iterations (e.g., a single iteration 250) of a phase estimation algorithm. For example, because the operations of the system 200 are initialized using the initial phase estimate 116 determined based on an output of the neural network 102, as opposed to a phase estimate that is not based on the audio data (such as a random or default phase estimate), the phase estimation algorithm can converge using a relatively small number of iterations to determine the target phase 118 for the reconstructed audio signal 120. As a non-limiting example, the system 200 can determine the target phase 118 based on the single iteration 250 as opposed to using hundreds of iterations if the phase estimation system 200 was initialized using a random phase estimate. As a result, processing efficiency and other performance metrics can be improved.

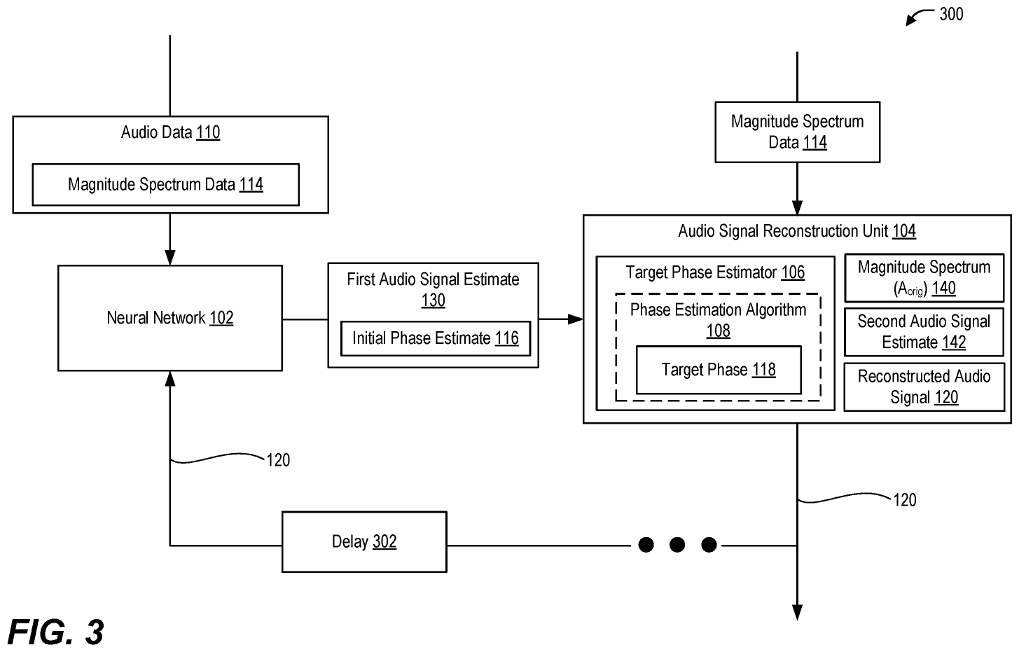

Referring to FIG. 3, a particular illustrative aspect of a system configured to provide feedback to a neural network based on a reconstructed audio signal is disclosed and generally designated 300. The system 300 includes similar components as the system 100 of FIG. 1 and can operate in a substantially similar manner. For example, the system 300 includes the neural network 102 and the audio signal reconstruction unit 104.

However, in the illustrated example of FIG. 3, a first reconstructed data sample associated with the reconstructed audio signal 120 is provided as an input to the neural network 102 as feedback after a delay 302. By providing the reconstructed audio signal 120 to the neural network 102, the reconstructed audio signal 120 can be used to generate a phase estimate for additional samples (e.g., one or more second samples) of the audio signal. For example, the neural network 102 can use magnitude and phase information from the first reconstructed data sample associated with the reconstructed audio signal 120 to generate phase estimates for one or more subsequent samples.

The techniques described with respect to FIG. 3 enable the neural network 102 to generate improved audio signal estimates. For example, by providing reconstructed data samples to the neural network 102 as feedback, the neural network 102 can generate improved outputs (e.g., signal estimates and phase estimates). The phase estimation algorithm 108 can be initialized using the improved initial phase estimates, which enables the phase estimation algorithm 108 to generate the reconstructed audio signal 120 in a manner that more accurately reproduces the original audio signal.

Referring to FIG. 4, a particular illustrative aspect of a system configured to generate an initial phase estimate for a phase estimation algorithm is disclosed and generally designated 400. The system 400 includes a frame-rate unit 402, a sample-rate unit 404, a filter 408, and a transform operation unit 410. According to one implementation, one or more components of the system 400 can be integrated into the neural network 102.

The frame-rate unit 402 can receive the audio data 110. According to one implementation, the audio data 110 corresponds to dequantized values received from an audio decoder, such as a decoder portion of a feedback recurrent autoencoder (FRAE), an adaptive multi-rate coder, etc. The frame-rate unit 402 can be configured to provide the audio data 110 to the sample-rate unit 404 at a particular frame rate. As a non-limiting example, if audio is captured at a rate of sixty frames per second, the frame-rate unit 402 can provide audio data 110 for a single frame every one-sixtieth of a second.

The sample-rate unit 404 can include two gated recurrent units (GRU) that can model a probability distribution of an excitation signal (eₜ). The excitation signal (eₜ) is sampled and combined with a prediction (Pₜ) from the filter 408 (e.g., an LPC filter) to generate an audio sample (sₜ). The transform operation unit 410 can perform a transform operation on the audio sample (sₜ) to generate the first audio signal estimate 130 that is provided to the audio signal reconstruction unit 104.

The reconstructed audio signal 120 and the audio sample (sₜ) are provided to the sample-rate unit 404 as feedback. The audio sample (sₜ) is subjected to a first delay 412, and the reconstructed audio signal 120 is subjected to a second delay 302. In a particular aspect, the first delay 412 is different than the second delay 302. By providing the reconstructed audio signal 120 to the sample-rate unit 404, the reconstructed audio signal 120 can be used to train the system 400 and improve future audio signal estimates from system 400.

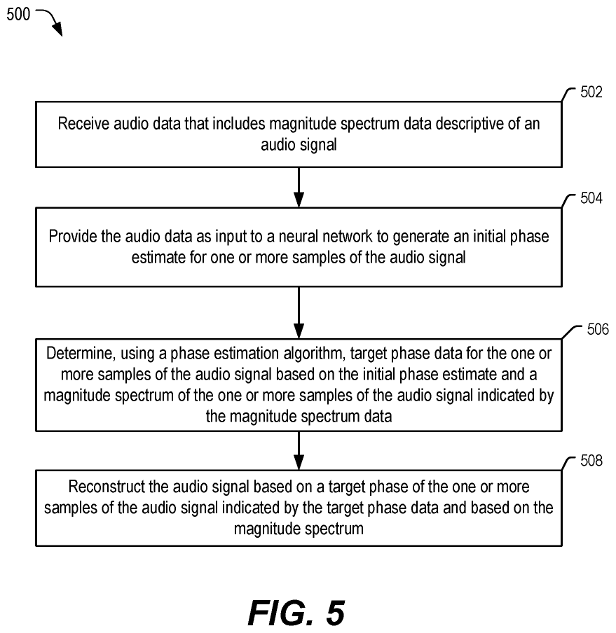

Referring to FIG. 5 a particular implementation of a method 500 of reconstructing an audio signal is shown. In a particular aspect, one or more operations of the method 500 are performed by the system 100 of FIG. 1, the system 200 of FIG. 2, the system 300 of FIG. 3, the system 400 of FIG. 4, or a combination thereof.

The method 500 includes receiving audio data that includes magnitude spectrum data descriptive of an audio signal, at block 502. For example, referring to FIG. 1, the system 100 receives the audio data 110 that includes the magnitude spectrum data 114.

The method 500 also includes providing the audio data as input to a neural network to generate an initial phase estimate for one or more samples of the audio signal, at block 504. For example, referring to FIG. 1, the audio data 110 is provided as input to the neural network 102 to generate the initial phase estimate 116. The neural network 102 can include an autoregressive neural network.

According to some implementations, the method 500 includes generating, using the neural network, a first audio signal estimate based on the audio data. For example, referring to FIG. 1, the neural network 102 generates the first audio signal estimate 130 based on the audio data 110. The method 500 can also include generating the initial phase estimate 116 based on the first audio signal estimate 130. For example, generating the initial phase estimate 116 can include performing a short-time Fourier transform (STFT) operation on the first audio signal estimate 130 to determine a magnitude (e.g., an amplitude) and a phase. The phase can correspond to the initial phase estimate 116.

The method 500 also includes determining, using a phase estimation algorithm, target phase data for the one or more samples of the audio signal based on the initial phase estimate and a magnitude spectrum associated with the magnitude spectrum data, at block 506. For example, referring to FIG. 2, the system 200 can determine the target phase 118 based on the initial phase estimate and the original magnitude spectrum (A_{orig}) 140.

The method 500 also includes reconstructing the audio signal based on a target phase of the one or more samples of the audio signal indicated by the target phase data and based on the magnitude spectrum, at block 508. For example, referring to FIG. 2, the system 200 can generate the reconstructed audio signal 120 based on the target phase 118 and the original magnitude spectrum (A_{orig}) 140. According to some implementations, the method 500 includes performing an inverse short-time Fourier transform (ISTFT) operation based on the initial phase estimate and the magnitude spectrum to generate a second audio signal estimate. For example, referring to FIG. 2, the inverse transform operation unit 206 can perform an ISTFT operation based on the initial phase estimate 116 and the original magnitude spectrum (A_{orig}) 140 to generate the second audio signal estimate 142. The method 500 can also include performing a short-time Fourier transform (STFT) on the second audio signal estimate to determine the target phase. For example, referring to FIG. 2, the transform operation unit 208 can perform a STFT operation on the second audio signal estimate 142 to determine the target phase 118. The method 500 can also include performing an ISTFT operation based on the target phase and the magnitude spectrum to reconstruct the audio signal. For example, referring to FIG. 2, the inverse transform operation unit 206 can perform an ISTFT operation based on the target phase 118 and the original magnitude spectrum (A_{orig}) 140 to generate the reconstructed audio signal 120.

According to some implementations, the method 500 can also include providing a first reconstructed data sample associated with the reconstructed audio signal as an input to the neural network to generate a phase estimate for one or more second samples of the audio signal. For example, referring to FIG. 3, the neural network 102 can receive the reconstructed audio signal 120 as feedback to generate additional phase estimates for other samples of the audio signal.

The method 500 of FIG. 5 reduces a memory footprint associated with generating the reconstructed audio signal 120 by using a low-complexity neural network 102. Additionally, because the phase estimation algorithm 108 is initialized using the initial phase estimate 116 determined based on an output of the neural network 102, as opposed to a phase estimate that is not based on the audio signal, the phase estimation algorithm 108 can undergo a relatively small number of iterations to determine the target phase 118 for the reconstructed audio signal 120. As a non-limiting example, the target phase estimator 106 can determine the target phase 118 based on a single iteration of the phase estimation algorithm 108 as opposed to using hundreds of iterations if the phase estimation algorithm 108 was initialized using a random phase estimate. As a result, processing efficiency and other performance metrics can be improved.

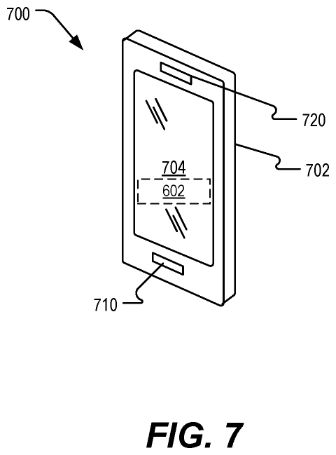

The method 500 may be implemented by a field programmable gate array (FPGA) device, an application-specific integrated circuit (ASIC), a processing unit such as a central processing unit (CPU), a digital signal processing unit (DSP), a controller, another hardware device, firmware device, or any combination thereof. As an example, the method 500 may be performed by a processor that executes instructions, such as described with reference to FIGS. 6-7.

FIG. 6 depicts an implementation 600 in which a device 602 includes one or more processors 610 that include components of the system 100 of FIG. 1. For example, the device 602 includes the neural network 102 and the audio signal reconstruction unit 104. Although not expressly illustrated, the device 602 can include one or more components of the system 200 of FIG. 2, the system 300 of FIG. 3, the system 400 of FIG. 4, or a combination thereof.

The device 602 also includes an input interface 604 (e.g., one or more wired or wireless interfaces) configured to receive the audio data 110 and an output interface 606 (e.g., one or more wired or wireless interfaces) configured to provide the reconstructed audio signal 120 to a playback device (e.g., a speaker). According to one implementation, the input interface 604 can receive the audio data 110 from an audio decoder. The device 602 may correspond to a system-on-chip or other modular device that can be integrated into other systems to provide audio decoding, such as within a mobile phone, another communication device, an entertainment system, or a vehicle, as illustrative, non-limiting examples. According to some implementations, the device 1302 may be integrated into a server, a mobile communication device, a smart phone, a cellular phone, a laptop computer, a computer, a tablet, a personal digital assistant, a display device, a television, a gaming console, a music player, a radio, a digital video player, a DVD player, a tuner, a camera, a navigation device, a headset, an augmented realty headset, a mixed reality headset, a virtual reality headset, a motor vehicle such as a car, or any combination thereof.

In the illustrated implementation 600, the device 602 includes a memory 620 (e.g., one or more memory devices) that includes instructions 622. The device 602 also includes one or more processors 610 coupled to the memory 620 and configured to execute the instructions 622 from the memory 620. In the implementation 600, the neural network 102 and/or the audio signal reconstruction unit 104 may correspond to or be implemented via the instructions 622. For example, when the instructions 622 are executed by the processor(s) 610, the processor(s) 610 may receive the audio data 110 that includes the magnitude spectrum data 114 descriptive of the audio signal. The processor(s) 610 may further provide the audio data 110 as input to the neural network 102 to generate the initial phase estimate 116 for one or more samples of the audio signal. The processor(s) 610 may also determine, using the phase estimation algorithm 108, the target phase 118 for the one or more samples of the audio signal based on the initial phase estimate 116 and the magnitude spectrum 140 of the one or more samples of the audio signal indicated by the magnitude spectrum data 114. The processor(s) 610 may also reconstruct the audio signal (e.g., generate the reconstructed audio signal 120) based on the target phase 118 and the magnitude spectrum 140.

FIG. 7 depicts an implementation 700 in which the device 602 is integrated into a mobile device 702, such as a phone or tablet, as illustrative, non-limiting examples. The mobile device 702 includes a microphone 710 positioned to primarily capture speech of a user, a speaker 720 configured to output sound, and a display screen 704. The device 602 may receive audio data (e.g., the audio data 110) that includes magnitude spectrum data (e.g., the magnitude spectrum data 114) descriptive of the audio signal. For example, the audio data can be transmitted to the mobile device 702 as part of an encoded bitstream. The device 602 may further provide the audio data as input to a neural network (e.g., the neural network 102) to generate an initial phase estimate (e.g., the initial phase estimate 116) for one or more samples of the audio signal. The device 602 may also determine, using a phase estimation algorithm (e.g., the phase estimation algorithm 108), a target phase (e.g., the target phase 118) for the one or more samples of the audio signal based on the initial phase estimate and the magnitude spectrum of the one or more samples of the audio signal indicated by the magnitude spectrum data. The device 602 may also reconstruct the audio signal (e.g., generate the reconstructed audio signal 120) based on the target phase and the magnitude spectrum. The reconstructed audio signal can be processed and output by the speaker 720 as sound.

FIG. 8 depicts an implementation 800 in which the device 602 is integrated into a headset device 802. The headset device 802 includes a microphone 810 positioned to primarily capture speech of a user and one or more earphones 820. The device 602 may receive audio data (e.g., the audio data 110) that includes magnitude spectrum data (e.g., the magnitude spectrum data 114) descriptive of the audio signal. As a non-limiting example, the audio data can be transmitted to the headset device 802 as part of an encoded bitstream or as part of a media bitstream. The device 602 may further provide the audio data as input to a neural network (e.g., the neural network 102) to generate an initial phase estimate (e.g., the initial phase estimate 116) for one or more samples of the audio signal. The device 602 may also determine, using a phase estimation algorithm (e.g., the phase estimation algorithm 108), a target phase (e.g., the target phase 118) for the one or more samples of the audio signal based on the initial phase estimate and the magnitude spectrum of the one or more samples of the audio signal indicated by the magnitude spectrum data. The device 602 may also reconstruct the audio signal (e.g., generate the reconstructed audio signal 120) based on the target phase and the magnitude spectrum. The reconstructed audio signal can be processed and output by the earphones 820 as sound.

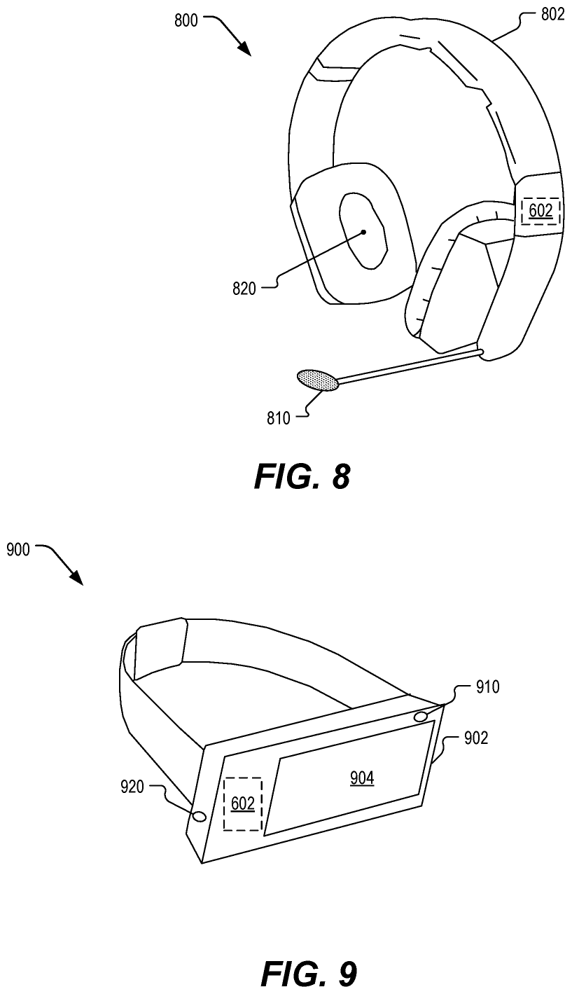

FIG. 9 depicts an implementation 900 in which the device 602 is integrated into a wearable electronic device 902, illustrated as a “smart watch.” The wearable electronic device 902 can include a microphone 910, a speaker 920, and a display screen 904. The device 602 may receive audio data (e.g., the audio data 110) that includes magnitude spectrum data (e.g., the magnitude spectrum data 114) descriptive of the audio signal. For example, the audio data can be transmitted to the wearable electronic device 902 as part of an encoded bitstream. The device 602 may further provide the audio data as input to a neural network (e.g., the neural network 102) to generate an initial phase estimate (e.g., the initial phase estimate 116) for one or more samples of the audio signal. The device 602 may also determine, using a phase estimation algorithm (e.g., the phase estimation algorithm 108), a target phase (e.g., the target phase 118) for the one or more samples of the audio signal based on the initial phase estimate and the magnitude spectrum of the one or more samples of the audio signal indicated by the magnitude spectrum data. The device 602 may also reconstruct the audio signal (e.g., generate the reconstructed audio signal 120) based on the target phase and the magnitude spectrum. The reconstructed audio signal can be processed and output by the speaker 920 as sound.

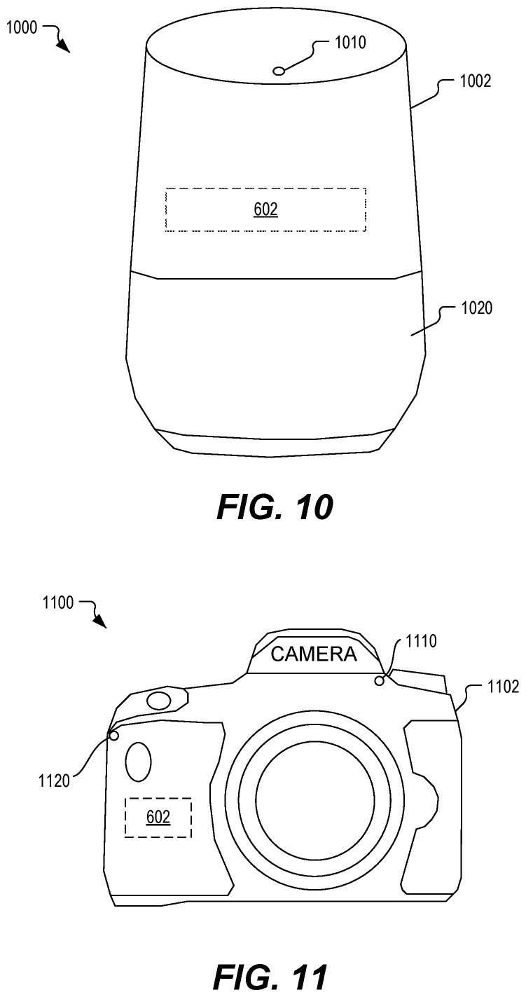

FIG. 10 is an implementation 1000 in which the device 602 is integrated into a wireless speaker and voice activated device 1002. The wireless speaker and voice activated device 1002 can have wireless network connectivity and is configured to execute an assistant operation. The wireless speaker and voice activated device 1002 includes a microphone 1010 and a speaker 1020. The device 602 may receive audio data (e.g., the audio data 110) that includes magnitude spectrum data (e.g., the magnitude spectrum data 114) descriptive of the audio signal. The device 602 may further provide the audio data as input to a neural network (e.g., the neural network 102) to generate an initial phase estimate (e.g., the initial phase estimate 116) for one or more samples of the audio signal. The device 602 may also determine, using a phase estimation algorithm (e.g., the phase estimation algorithm 108), a target phase (e.g., the target phase 118) for the one or more samples of the audio signal based on the initial phase estimate and the magnitude spectrum of the one or more samples of the audio signal indicated by the magnitude spectrum data. The device 602 may also reconstruct the audio signal (e.g., generate the reconstructed audio signal 120) based on the target phase and the magnitude spectrum. The reconstructed audio signal can be processed and output by the speaker 1020 as sound.

FIG. 11 depicts an implementation 1100 in which the device 602 is integrated into a portable electronic device that corresponds to a camera device 1102. The camera device 1102 includes a microphone 1110 and a speaker 1120. The device 602 may receive audio data (e.g., the audio data 110) that includes magnitude spectrum data (e.g., the magnitude spectrum data 114) descriptive of the audio signal. The device 602 may further provide the audio data as input to a neural network (e.g., the neural network 102) to generate an initial phase estimate (e.g., the initial phase estimate 116) for one or more samples of the audio signal. The device 602 may also determine, using a phase estimation algorithm (e.g., the phase estimation algorithm 108), a target phase (e.g., the target phase 118) for the one or more samples of the audio signal based on the initial phase estimate and the magnitude spectrum of the one or more samples of the audio signal indicated by the magnitude spectrum data. The device 602 may also reconstruct the audio signal (e.g., generate the reconstructed audio signal 120) based on the target phase and the magnitude spectrum. The reconstructed audio signal can be processed and output by the speaker 1120 as sound.

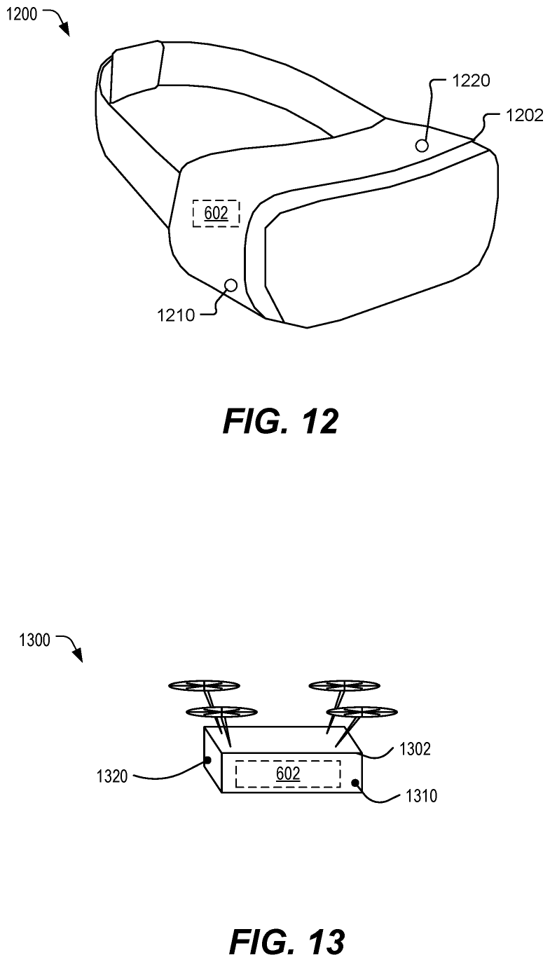

FIG. 12 depicts an implementation 1200 in which the device 602 is integrated into a portable electronic device that corresponds to an extended reality (“XR”) headset 1202, such as a virtual reality (“VR”), augmented reality (“AR”), or mixed reality (“MR”) headset device. A visual interface device is positioned in front of the user's eyes to enable display of augmented reality or virtual reality images or scenes to the user while the headset 1202 is worn. The device 602 may receive audio data (e.g., the audio data 110) that includes magnitude spectrum data (e.g., the magnitude spectrum data 114) descriptive of the audio signal. The device 602 may further provide the audio data as input to a neural network (e.g., the neural network 102) to generate an initial phase estimate (e.g., the initial phase estimate 116) for one or more samples of the audio signal. The device 602 may also determine, using a phase estimation algorithm (e.g., the phase estimation algorithm 108), a target phase (e.g., the target phase 118) for the one or more samples of the audio signal based on the initial phase estimate and the magnitude spectrum of the one or more samples of the audio signal indicated by the magnitude spectrum data. The device 602 may also reconstruct the audio signal (e.g., generate the reconstructed audio signal 120) based on the target phase and the magnitude spectrum. The reconstructed audio signal can be processed and output by a speaker 1220. In a particular example, the visual interface device is configured to display a notification indicating user speech from a microphone 1210 or a notification indicating user speech from the sound output by the speaker 1220.

FIG. 13 depicts an implementation 1300 in which the device 602 corresponds to or is integrated within a vehicle 1302, illustrated as a manned or unmanned aerial device (e.g., a package delivery drone). The vehicle 1302 includes a microphone 1310 and a speaker 1320. The device 602 may receive audio data (e.g., the audio data 110) that includes magnitude spectrum data (e.g., the magnitude spectrum data 114) descriptive of the audio signal. The device 602 may further provide the audio data as input to a neural network (e.g., the neural network 102) to generate an initial phase estimate (e.g., the initial phase estimate 116) for one or more samples of the audio signal. The device 602 may also determine, using a phase estimation algorithm (e.g., the phase estimation algorithm 108), a target phase (e.g., the target phase 118) for the one or more samples of the audio signal based on the initial phase estimate and the magnitude spectrum of the one or more samples of the audio signal indicated by the magnitude spectrum data. The device 602 may also reconstruct the audio signal (e.g., generate the reconstructed audio signal 120) based on the target phase and the magnitude spectrum. The reconstructed audio signal can be processed and output by the speaker 1320 as sound.

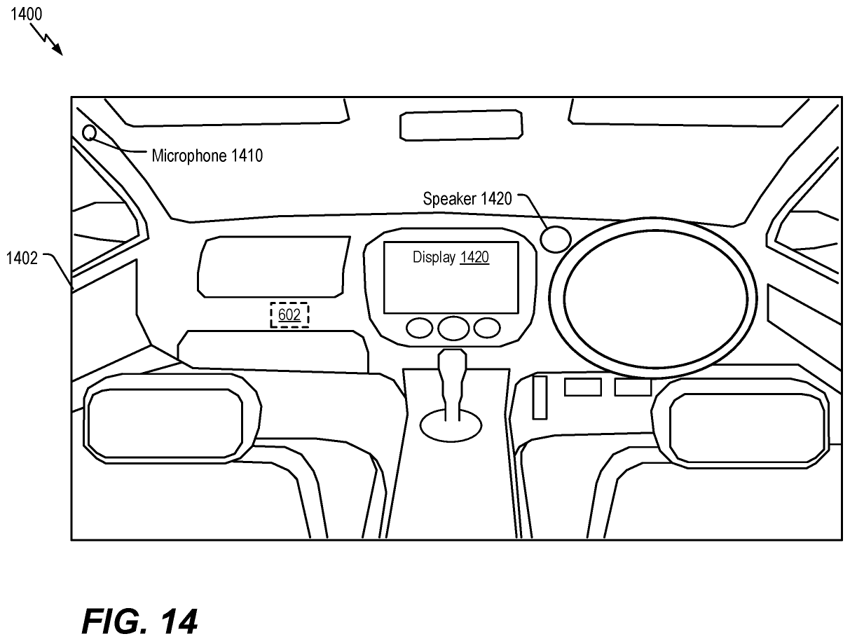

FIG. 14 depicts another implementation 1400 in which the device 602 corresponds to, or is integrated within, a vehicle 1402, illustrated as a car. The vehicle 1402 also includes a microphone 1410 and a speaker 1420. The microphone 1410 is positioned to capture utterances of an operator of the vehicle 1402. The device 602 may receive audio data (e.g., the audio data 110) that includes magnitude spectrum data (e.g., the magnitude spectrum data 114) descriptive of the audio signal. The device 602 may further provide the audio data as input to a neural network (e.g., the neural network 102) to generate an initial phase estimate (e.g., the initial phase estimate 116) for one or more samples of the audio signal. The device 602 may also determine, using a phase estimation algorithm (e.g., the phase estimation algorithm 108), a target phase (e.g., the target phase 118) for the one or more samples of the audio signal based on the initial phase estimate and the magnitude spectrum of the one or more samples of the audio signal indicated by the magnitude spectrum data. The device 602 may also reconstruct the audio signal (e.g., generate the reconstructed audio signal 120) based on the target phase and the magnitude spectrum. The reconstructed audio signal can be processed and output by the speaker 1420 as sound. One or more operations of the vehicle 1402 may be initiated based on one or more keywords (e.g., “unlock”, “start engine”, “play music”, “display weather forecast”, or another voice command) detected, such as by providing feedback or information via a display 1420 or the speaker 1420.

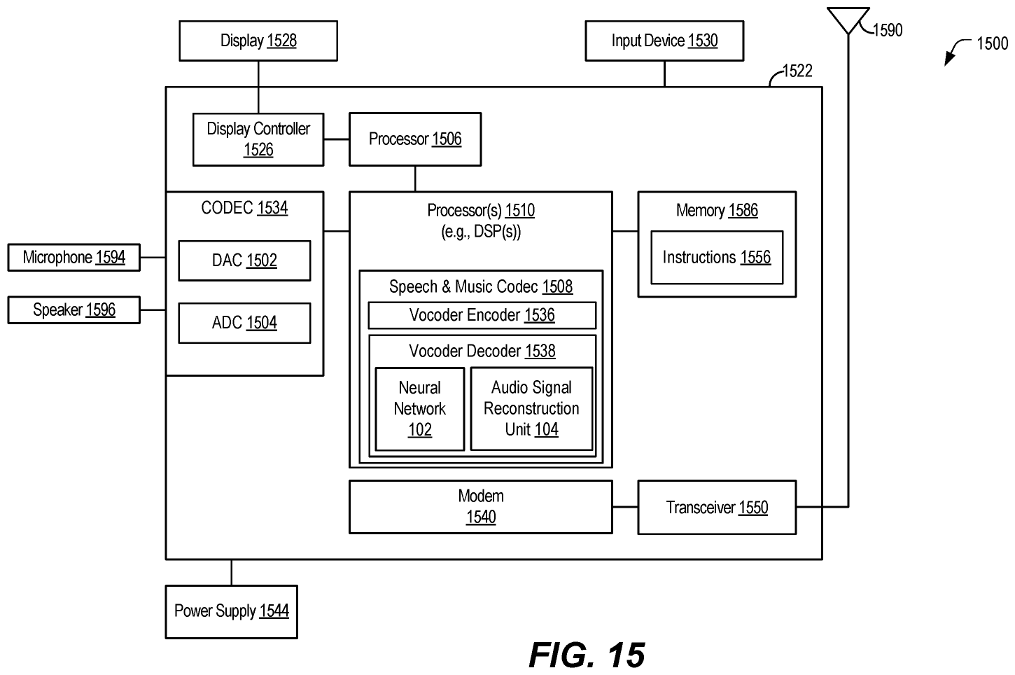

Referring to FIG. 15, a block diagram of a particular illustrative implementation of a device is depicted and generally designated 1500. In various implementations, the device 1500 may have more or fewer components than illustrated in FIG. 15. In an illustrative implementation, the device 1500 may perform one or more operations described with reference to FIGS. 1-14.

In a particular implementation, the device 1500 includes a processor 1506 (e.g., a CPU). The device 1500 may include one or more additional processors 1510 (e.g., one or more digital signal processors (DSPs), one or more graphics processing units (GPUs), or a combination thereof). The processor(s) 1510 may include a speech and music coder-decoder (CODEC) 1508. The speech and music codec 1508 may include a voice coder (“vocoder”) encoder 1536, a vocoder decoder 1538, or both. In a particular aspect, the vocoder decoder 1538 includes the neural network 102 and the audio signal reconstruction unit 104. Although not expressly illustrated, the vocoder decoder 1538 can include one or more components of the system 200 of FIG. 2, the system 300 of FIG. 3, the system 400 of FIG. 4, or a combination thereof.

The device 1500 also includes a memory 1586 and a CODEC 1534. The memory 1586 may include instructions 1556 that are executable by the one or more additional processors 1510 (or the processor 1506) to implement the functionality described with reference to the system 100 of FIG. 1, the system 200 of FIG. 2, the system 300 of FIG. 3, the system 400 of FIG. 4, or a combination thereof. The device 1500 may include a modem 1540 coupled, via a transceiver 1550, to an antenna 1590.

The device 1500 may include a display 1528 coupled to a display controller 1526. A speaker 1596 and a microphone 1594 may be coupled to the CODEC 1534. The CODEC 1534 may include a digital-to-analog converter (DAC) 1502 and an analog-to-digital converter (ADC) 1504. In a particular implementation, the CODEC 1534 may receive an analog signal from the microphone 1594, convert the analog signal to a digital signal using the analog-to-digital converter 1504, and provide the digital signal to the speech and music codec 1508. The speech and music codec 1508 may process the digital signals. In a particular implementation, the speech and music codec 1508 may provide digital signals to the CODEC 1534. According to one implementation, the CODEC 1534 can process the digital signals according to the techniques described with respect to FIGS. 1-14 to generate the reconstructed audio signal 120. The CODEC 1534 may convert the digital signals (e.g., the reconstructed audio signal 120) to analog signals using the digital-to-analog converter 1502 and may provide the analog signals to the speaker 1596.

In a particular implementation, the device 1500 may be included in a system-in-package or system-on-chip device 1522. In a particular implementation, the memory 1586, the processor 1506, the processor(s) 1510, the display controller 1526, the CODEC 1534, and the modem 1540 are included in the system-in-package or system-on-chip device 1522. In a particular implementation, an input device 1530 and a power supply 1544 are coupled to the system-in-package or system-on-chip device 1522. Moreover, in a particular implementation, as illustrated in FIG. 15, the display 1528, the input device 1530, the speaker 1596, the microphone 1594, the antenna 1590, and the power supply 1544 are external to the system-in-package or system-on-chip device 1522. In a particular implementation, each of the display 1528, the input device 1530, the speaker 1596, the microphone 1594, the antenna 1590, and the power supply 1544 may be coupled to a component of the system-in-package or system-on-chip device 1522, such as an interface or a controller. In some implementations, the device 1500 includes additional memory that is external to the system-in-package or system-on-chip device 1522 and coupled to the system-in-package or system-on-chip device 1522 via an interface or controller.

The device 1500 may include a smart speaker (e.g., the processor 1506 may execute the instructions 1556 to run a voice-controlled digital assistant application), a speaker bar, a mobile communication device, a smart phone, a cellular phone, a laptop computer, a computer, a tablet, a personal digital assistant, a display device, a television, a gaming console, a music player, a radio, a digital video player, a DVD player, a tuner, a camera, a navigation device, a headset, an augmented realty headset, a mixed reality headset, a virtual reality headset, a vehicle, or any combination thereof.

In conjunction with the described implementations, an apparatus includes means for receiving audio data that includes magnitude spectrum data descriptive of an audio signal. For example, the means for receiving includes the neural network 102, the audio signal reconstruction unit 104, the magnitude spectrum selector 204, the frame-rate unit 402, the input interface 604, the processor(s) 610, the processor 1506, the processor(s) 1510, the modem 1540, the transceiver 1550, the speech and music codec 1508, the vocoder decoder 1538 of FIG. 15, one or more other circuits or components configured to receive the audio data, or any combination thereof.

The apparatus also includes means for providing the audio data as input to a neural network to generate an initial phase estimate for one or more samples of the audio signal. For example, the means for providing the audio data as input to the neural network includes the processor(s) 610, the processor 1506, the processor(s) 1510, the speech and music codec 1508, the vocoder decoder 1538 of FIG. 15, one or more other circuits or components configured to provide the audio data as input to the neural network, or any combination thereof.

The apparatus also includes means for determining, using a phase estimation algorithm, target phase data for the one or more samples of the audio signal based on the initial phase estimate and a magnitude spectrum of the one or more samples of the audio signal indicated by the magnitude spectrum data. For example, the means for determining the target phase data includes the audio signal reconstruction unit 104, the target phase estimator 106, the phase selector 202, the magnitude spectrum selector 204, the inverse transform operation unit 206, the transform operation unit 208, the processor(s) 610, the processor 1506, the processor(s) 1510, the speech and music codec 1508, the vocoder decoder 1538 of FIG. 15, one or more other circuits or components configured to determine the target phase data, or any combination thereof.

The apparatus also includes means for reconstructing the audio signal based on a target phase of the one or more samples of the audio signal indicated by the target phase data and based on the magnitude spectrum. For example, the means for reconstructing the audio signal includes the audio signal reconstruction unit 104, the target phase estimator 106, the phase selector 202, the magnitude spectrum selector 204, the inverse transform operation unit 206, the transform operation unit 208, the processor(s) 610, the processor 1506, the processor(s) 1510, the speech and music codec 1508, the vocoder decoder 1538 of FIG. 15, one or more other circuits or components configured to reconstruct the audio signal, or any combination thereof.

In some implementations, a non-transitory computer-readable medium includes instructions that, when executed by one or more processors of a device, cause the one or more processors to receive audio data (e.g., the audio data 110) that includes magnitude spectrum data (e.g., the magnitude spectrum data 114) descriptive of an audio signal. The instructions, when executed by the one or more processors, cause the one or more processors to provide the audio data as input to a neural network (e.g., the neural network 102) to generate an initial phase estimate (e.g., the initial phase estimate 116) for one or more samples of the audio signal. The instructions, when executed by the one or more processors, cause the one or more processors to determine, using a phase estimation algorithm (e.g., the phase estimation algorithm 108), target phase data (e.g., the target phase 118) for the one or more samples of the audio signal based on the initial phase estimate and a magnitude spectrum (e.g., the magnitude spectrum 140) of the one or more samples of the audio signal indicated by the magnitude spectrum data. The instructions, when executed by the one or more processors, cause the one or more processors to reconstruct the audio signal based on a target phase of the one or more samples of the audio signal indicated by the target phase data and based on the magnitude spectrum.

This disclosure includes the following examples.

Example 1 includes a device comprising: a memory; and one or more processors coupled to the memory and operably configured to: receive audio data that includes magnitude spectrum data descriptive of an audio signal; provide the audio data as input to a neural network to generate an initial phase estimate for one or more samples of the audio signal; determine, using a phase estimation algorithm, target phase data for the one or more samples of the audio signal based on the initial phase estimate and a magnitude spectrum of the one or more samples of the audio signal indicated by the magnitude spectrum data; and reconstruct the audio signal based on a target phase of the one or more samples of the audio signal indicated by the target phase data and based on the magnitude spectrum.

Example 2 includes the device of example 1, wherein the neural network is configured to generate, based on the audio data, a first audio signal estimate, and wherein the instructions, when executed, further cause the one or more processors to generate the initial phase estimate based on the first audio signal estimate.

Example 3 includes the device of example 2, wherein the one or more processors are operably configured to perform a short-time Fourier transform (STFT) operation on the first audio signal estimate to determine the initial phase estimate.

Example 4 includes the device of any of examples 1 to 3, wherein one or more processors are operably configured to: perform an inverse short-time Fourier transform (ISTFT) operation based on the initial phase estimate and the magnitude spectrum to generate a second audio signal estimate; perform a short-time Fourier transform (STFT) on the second audio signal estimate to determine the target phase; and perform an ISTFT operation based on the target phase and the magnitude spectrum to reconstruct the audio signal.

Example 5 includes the device of any of examples 1 to 4, wherein a first window associated with a first portion of the magnitude spectrum overlaps a second window associated with a second portion of the magnitude spectrum, wherein the first portion of the magnitude spectrum corresponds to a magnitude spectrum of a first sample of the one or more samples, and wherein the second portion of the magnitude spectrum corresponds to a magnitude spectrum of a second sample of the one or more samples.

Example 6 includes the device of example 5, wherein at least one sample of the first window overlaps with at least one sample of the second window.

Example 7 includes the device of any of examples 1 to 6, wherein the one or more processors are operably configured to: provide a first reconstructed data sample associated with the reconstructed audio signal as an input to the neural network to generate a phase estimate for one or more second samples of the audio signal.

Example 8 includes the device of any of examples 1 to 7, wherein the neural network comprises an autoregressive neural network.

Example 9 includes the device of any of examples 1 to 8, wherein the phase estimation algorithm corresponds to a Griffin-Lim algorithm, and wherein the target phase data is determined using one iteration of the Griffin-Lim algorithm or two iterations of the Griffin-Lim algorithm.

Example 10 includes the device of any of examples 1 to 9, wherein the audio data corresponds to dequantized values received from an audio decoder.

Example 11 includes a method comprising: receiving audio data that includes magnitude spectrum data descriptive of an audio signal; providing the audio data as input to a neural network to generate an initial phase estimate for one or more samples of the audio signal; determining, using a phase estimation algorithm, target phase data for the one or more samples of the audio signal based on the initial phase estimate and a magnitude spectrum of the one or more samples of the audio signal indicated by the magnitude spectrum data; and reconstructing the audio signal based on a target phase of the one or more samples of the audio signal indicated by the target phase data and based on the magnitude spectrum.

Example 12 includes the method of example 11, further comprising: generating, based on the audio data, a first audio signal estimate based on the audio data using the neural network; and generating the initial phase estimate based on the first audio signal estimate.

Example 13 includes the method of example 12, wherein generating the initial phase estimate comprises performing a short-time Fourier transform (STFT) operation on the first audio signal estimate.

Example 14 includes the method of any of examples 11 to 13, further comprising: performing an inverse short-time Fourier transform (ISTFT) operation based on the initial phase estimate and the magnitude spectrum to generate a second audio signal estimate; performing a short-time Fourier transform (STFT) on the second audio signal estimate to determine the target phase; and performing an ISTFT operation based on the target phase and the magnitude spectrum to reconstruct the audio signal.

Example 15 includes the method of any of examples 11 to 14, wherein a first window associated with a first portion of the magnitude spectrum overlaps a second window associated with a second portion of the magnitude spectrum, wherein the first portion of the magnitude spectrum corresponds to a magnitude spectrum of a first sample of the one or more samples, and wherein the second portion of the magnitude spectrum corresponds to a magnitude spectrum of a second sample of the one or more samples.

Example 16 includes the method of example 15, wherein at least one sample of the first window overlaps with at least one sample of the second window.

Example 17 includes the method of any of examples 11 to 16, further comprising: providing a first reconstructed data sample associated with the reconstructed audio signal as an input to the neural network to generate a phase estimate for one or more second samples of the audio signal.

Example 18 includes the method of any of examples 11 to 17, wherein the neural network comprises an autoregressive neural network.

Example 19 includes the method of any of examples 11 to 18, wherein the phase estimation algorithm corresponds to a Griffin-Lim algorithm, and wherein the target phase data is determined using five or fewer iterations of the Griffin-Lim algorithm.

Example 20 includes the method of any of examples 11 to 19, wherein using the phase estimation algorithm with the neural network to reconstruct the audio signal enables the neural network to be a low-complexity neural network.

Example 21 includes a non-transitory computer-readable medium comprising instructions that, when executed by one or more processors, cause the one or more processors to: receive audio data that includes magnitude spectrum data descriptive of an audio signal; provide the audio data as input to a neural network to generate an initial phase estimate for one or more samples of the audio signal; determine, using a phase estimation algorithm, target phase data for the one or more samples of the audio signal based on the initial phase estimate and a magnitude spectrum of the one or more samples of the audio signal indicated by the magnitude spectrum data; and reconstruct the audio signal based on a target phase of the one or more samples of the audio signal indicated by the target phase data and based on the magnitude spectrum.

Example 22 includes the non-transitory computer-readable medium of example 21, wherein the neural network is configured to generate, based on the audio data, a first audio signal estimate, and wherein the instructions, when executed, further cause the one or more processors to generate the initial phase estimate based on the first audio signal estimate.

Example 23 includes the non-transitory computer-readable medium of example 22, wherein the instructions, when executed, cause the one or more processors to perform a short-time Fourier transform (STFT) operation on the first audio signal estimate to determine the initial phase estimate.

Example 24 includes the non-transitory computer-readable medium of any of examples 21 to 23, wherein the instructions, when executed, further cause the one or more processors to: perform an inverse short-time Fourier transform (ISTFT) operation based on the initial phase estimate and the magnitude spectrum to generate a second audio signal estimate; perform a short-time Fourier transform (STFT) on the second audio signal estimate to determine the target phase; and perform an ISTFT operation based on the target phase and the magnitude spectrum to reconstruct the audio signal.

Example 25 includes the non-transitory computer-readable medium of any of examples 21 to 24, wherein a first window associated with a first portion of the magnitude spectrum overlaps a second window associated with a second portion of the magnitude spectrum, wherein the first portion of the magnitude spectrum corresponds to a magnitude spectrum of a first sample of the one or more samples, and wherein the second portion of the magnitude spectrum corresponds to a magnitude spectrum of a second sample of the one or more samples.

Example 26 includes the non-transitory computer-readable medium of any of examples 21 to 25, wherein at least one sample of the first window overlaps with at least one sample of the second window.

Example 27 includes the non-transitory computer-readable medium of any of examples 21 to 26, wherein the instructions, when executed, further cause the one or more processors to: provide a first reconstructed data sample associated with the reconstructed audio signal as an input to the neural network to generate a phase estimate for one or more second samples of the audio signal.

Example 28 includes the non-transitory computer-readable medium of any of examples 21 to 27, wherein the neural network comprises an autoregressive neural network.

Example 29 includes the non-transitory computer-readable medium of any of examples 21 to 28, wherein the phase estimation algorithm corresponds to a Griffin-Lim algorithm, and wherein the target phase data is determined using five or fewer iterations of the Griffin-Lim algorithm.

Example 30 includes the non-transitory computer-readable medium of any of examples 21 to 29, wherein the audio data corresponds to dequantized values received from an audio decoder.

Example 31 includes an apparatus comprising: means for receiving audio data that includes magnitude spectrum data descriptive of an audio signal; means for providing the audio data as input to a neural network to generate an initial phase estimate for one or more samples of the audio signal; means for determining, using a phase estimation algorithm, target phase data for the one or more samples of the audio signal based on the initial phase estimate and a magnitude spectrum of the one or more samples of the audio signal indicated by the magnitude spectrum data; and means for reconstructing the audio signal based on a target phase of the one or more samples of the audio signal indicated by the target phase data and based on the magnitude spectrum.

Example 32 includes the apparatus of example 31, further comprising: means for generating, based on the audio data, a first audio signal estimate based on the audio data using the neural network; and means for generating the initial phase estimate based on the first audio signal estimate.

Example 33 includes the apparatus of any of examples 31 to 32, wherein generating the initial phase estimate comprises performing a short-time Fourier transform (STFT) operation on the first audio signal estimate.

Example 34 includes the apparatus of any of examples 31 to 33, further comprising: means for performing an inverse short-time Fourier transform (ISTFT) operation based on the initial phase estimate and the magnitude spectrum to generate a second audio signal estimate; means for performing a short-time Fourier transform (STFT) on the second audio signal estimate to determine the target phase; and means for performing an ISTFT operation based on the target phase and the magnitude spectrum to reconstruct the audio signal.

Example 35 includes the apparatus of any of examples 31 to 34, wherein a first window associated with a first portion of the magnitude spectrum overlaps a second window associated with a second portion of the magnitude spectrum, wherein the first portion of the magnitude spectrum corresponds to a magnitude spectrum of a first sample of the one or more samples, and wherein the second portion of the magnitude spectrum corresponds to a magnitude spectrum of a second sample of the one or more samples.

Example 36 includes the apparatus of any of examples 31 to 35, wherein at least one sample of the first window overlaps with at least one sample of the second window.

Example 37 includes the apparatus of any of examples 31 to 36, further comprising: means for providing a first reconstructed data sample associated with the reconstructed audio signal as an input to the neural network to generate a phase estimate for one or more second samples of the audio signal.

Example 38 includes the apparatus of any of examples 31 to 37, wherein the neural network comprises an autoregressive neural network.

Example 39 includes the apparatus of any of examples 31 to 38, wherein the phase estimation algorithm corresponds to a Griffin-Lim algorithm, and wherein the target phase data is determined using five or fewer iterations of the Griffin-Lim algorithm.

Example 40 includes the apparatus of any of examples 31 to 39, wherein the audio data corresponds to dequantized values received from an audio decoder.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory; and
one or more processors coupled to the memory and operably configured to:
receive audio data that includes magnitude spectrum data descriptive of an audio signal;
provide the audio data as input to a neural network to generate an initial phase estimate for one or more samples of the audio signal;
determine, using a phase estimation algorithm, target phase data for the one or more samples of the audio signal based on the initial phase estimate and a magnitude spectrum of the one or more samples of the audio signal indicated by the magnitude spectrum data; and
reconstruct the audio signal based on a target phase of the one or more samples of the audio signal indicated by the target phase data and based on the magnitude spectrum.

2. The device of claim 1, wherein the neural network is configured to generate, based on the audio data, a first audio signal estimate, and wherein the instructions, when executed, further cause the one or more processors to generate the initial phase estimate based on the first audio signal estimate.

3. The device of claim 2, wherein the one or more processors are operably configured to perform a short-time Fourier transform (STFT) operation on the first audio signal estimate to determine the initial phase estimate.

4. The device of claim 1, wherein the one or more processors are operably configured to:
perform an inverse short-time Fourier transform (ISTFT) operation based on the initial phase estimate and the magnitude spectrum to generate a second audio signal estimate;
perform a short-time Fourier transform (STFT) on the second audio signal estimate to determine the target phase; and
perform an ISTFT operation based on the target phase and the magnitude spectrum to reconstruct the audio signal.

5. The device of claim 1, wherein a first window associated with a first portion of the magnitude spectrum overlaps a second window associated with a second portion of the magnitude spectrum, wherein the first portion of the magnitude spectrum corresponds to a magnitude spectrum of a first sample of the one or more samples, and wherein the second portion of the magnitude spectrum corresponds to a magnitude spectrum of a second sample of the one or more samples.

6. The device of claim 5, wherein at least one sample of the first window overlaps with at least one sample of the second window.

7. The device of claim 1, wherein the one or more processors are operably configured to:
provide a first reconstructed data sample associated with the reconstructed audio signal as an input to the neural network to generate a phase estimate for one or more second samples of the audio signal.

8. The device of claim 1, wherein the neural network comprises an autoregressive neural network.

9. The device of claim 1, wherein the phase estimation algorithm corresponds to a Griffin-Lim algorithm, and wherein the target phase data is determined using five or fewer iterations of the Griffin-Lim algorithm.

10. The device of claim 1, wherein the audio data corresponds to dequantized values received from an audio decoder.

11. A method comprising:
receiving audio data that includes magnitude spectrum data descriptive of an audio signal;
providing the audio data as input to a neural network to generate an initial phase estimate for one or more samples of the audio signal;
determining, using a phase estimation algorithm, target phase data for the one or more samples of the audio signal based on the initial phase estimate and a magnitude spectrum of the one or more samples of the audio signal indicated by the magnitude spectrum data; and
reconstructing the audio signal based on a target phase of the one or more samples of the audio signal indicated by the target phase data and based on the magnitude spectrum.

12. The method of claim 11, further comprising:
generating, based on the audio data, a first audio signal estimate based on the audio data using the neural network; and
generating the initial phase estimate based on the first audio signal estimate.

13. The method of claim 12, wherein generating the initial phase estimate comprises performing a short-time Fourier transform (STFT) operation on the first audio signal estimate.

14. The method of claim 11, further comprising:
performing an inverse short-time Fourier transform (ISTFT) operation based on the initial phase estimate and the magnitude spectrum to generate a second audio signal estimate;
performing a short-time Fourier transform (STFT) on the second audio signal estimate to determine the target phase; and
performing an ISTFT operation based on the target phase and the magnitude spectrum to reconstruct the audio signal.

15. The method of claim 11, wherein a first window associated with a first portion of the magnitude spectrum overlaps a second window associated with a second portion of the magnitude spectrum, wherein the first portion of the magnitude spectrum corresponds to a magnitude spectrum of a first sample of the one or more samples, and wherein the second portion of the magnitude spectrum corresponds to a magnitude spectrum of a second sample of the one or more samples.

16. The method of claim 15, wherein one sample of the first window overlaps one sample of the second window.

17. The method of claim 11, further comprising:
providing a first reconstructed data sample associated with the reconstructed audio signal as an input to the neural network to generate a phase estimate for one or more second samples of the audio signal.

18. The method of claim 11, wherein the neural network comprises an autoregressive neural network.

19. The method of claim 11, wherein the phase estimation algorithm corresponds to a Griffin-Lim algorithm, and wherein the target phase data is determined using five or fewer iterations of the Griffin-Lim algorithm.

20. The method of claim 11, wherein using the phase estimation algorithm with the neural network to reconstruct the audio signal enables the neural network to be a low-complexity neural network.

21. A non-transitory computer-readable medium comprising instructions that, when executed by one or more processors, cause the one or more processors to:
receive audio data that includes magnitude spectrum data descriptive of an audio signal;
provide the audio data as input to a neural network to generate an initial phase estimate for one or more samples of the audio signal;
determine, using a phase estimation algorithm, target phase data for the one or more samples of the audio signal based on the initial phase estimate and a magnitude spectrum of the one or more samples of the audio signal indicated by the magnitude spectrum data; and
reconstruct the audio signal based on a target phase of the one or more samples of the audio signal indicated by the target phase data and based on the magnitude spectrum.

22. The non-transitory computer-readable medium of claim 21, wherein the neural network is configured to generate, based on the audio data, a first audio signal estimate, and wherein the instructions, when executed, further cause the one or more processors to generate the initial phase estimate based on the first audio signal estimate.

23. The non-transitory computer-readable medium of claim 22, wherein the instructions, when executed, cause the one or more processors to perform a short-time Fourier transform (STFT) operation on the first audio signal estimate to determine the initial phase estimate.

24. The non-transitory computer-readable medium of claim 21, wherein the instructions, when executed, further cause the one or more processors to:
perform an inverse short-time Fourier transform (ISTFT) operation based on the initial phase estimate and the magnitude spectrum to generate a second audio signal estimate;
perform a short-time Fourier transform (STFT) on the second audio signal estimate to determine the target phase; and
perform an ISTFT operation based on the target phase and the magnitude spectrum to reconstruct the audio signal.

25. The non-transitory computer-readable medium of claim 21, wherein a first window associated with a first portion of the magnitude spectrum overlaps a second window associated with a second portion of the magnitude spectrum, wherein the first portion of the magnitude spectrum corresponds to a magnitude spectrum of a first sample of the one or more samples, and wherein the second portion of the magnitude spectrum corresponds to a magnitude spectrum of a second sample of the one or more samples.

26. The non-transitory computer-readable medium of claim 21, wherein the neural network comprises an autoregressive neural network.

27. The non-transitory computer-readable medium of claim 21, wherein the phase estimation algorithm corresponds to a Griffin-Lim algorithm, and wherein the target phase data is determined using five or fewer iterations of the Griffin-Lim algorithm.

28. The non-transitory computer-readable medium of claim 21, wherein the audio data corresponds to dequantized values received from an audio decoder.

29. An apparatus comprising:
means for receiving audio data that includes magnitude spectrum data descriptive of an audio signal;
means for providing the audio data as input to a neural network to generate an initial phase estimate for one or more samples of the audio signal;
means for determining, using a phase estimation algorithm, target phase data for the one or more samples of the audio signal based on the initial phase estimate and a magnitude spectrum of the one or more samples of the audio signal indicated by the magnitude spectrum data; and
means for reconstructing the audio signal based on a target phase of the one or more samples of the audio signal indicated by the target phase data and based on the magnitude spectrum.

30. The apparatus of claim 29, wherein the audio data corresponds to dequantized values received from an audio decoder.
